(19) United States
(12) Patent Application Publication
(10) Pub. No.: US 2024/0302720 A1
(43) Pub. Date: Sep. 12, 2024

(54) Image Capture Device Holder

(71) Applicant: Shimmee Ltd., London (GB)

(72) Inventors: Charles Melvoin, Bristol (GB); William Soper, Bristol (GB); Gary Poolman, Bristol (GB)

(21) Appl. No.: 18/180,196

(22) Filed: Mar. 8, 2023

(51) Int. Cl. G03B 17/56; F16M 13/02; H04N 7/18

(52) U.S. Cl. CPC G03B 17/561; F16M 13/02; H04N 7/185

(57) ABSTRACT

A holder for holding an image capture device, the holder comprising: a holding portion for holding an image capture device; a connector disposed on a first side of the holding portion, the connector being arranged to couple the holder to a book; and a cover coupled to the holding portion and arranged on the first side of the holding portion, the connector being arranged to obscure the Image capture device from a viewer facing the first side of the holding portion, while allowing the image capture device to record images in the direction of the first side.

### BACKGROUND

Often parents or guardians want to capture images of their child during everyday activities such as reading. This may be for future reference or for contemporaneous communication with remote persons, such as relatives. However, when a child sees an image capture device the child may be distracted by the device such that their behaviour changes in order to touch or investigate the device. This may reduce the quality of the footage obtained with the image capture device.

The present inventor has therefore sought to provide a means for concealing an image capture device in order to capture images of a child without the child being distracted or having their behaviour altered by the knowledge of the presence of the image capture device.

In particular, the situation where a child is reading a book or is having a book read to them may be a position where the child is calm and happy, meaning that it is a desirable time to capture images of the child. However, the interest garnered by a book may be significantly less than the interest garnered by an image capture device and so this may be a situation where it is particularly desirable to record a child and where the child may be particularly easily distracted.

### SUMMARY OF THE INVENTION

According to the first aspect of the invention, there is a provided a holder for holding an image capture device, the holder comprising: a holding portion for holding an image capture device; a connector disposed on a first side of the holding portion, the connector being arranged to couple the holder to a book; and a cover coupled to the holding portion and arranged on the first side of the holding portion, the cover and/or the holding portion being arranged to obscure the image capture device from a viewer facing the first side of the holding portion, while allowing the image capture device to record images in the direction of the first side.

By providing a holder for coupling an image capture device to a book, a parent may be able to concentrate on looking after a child and holding the book, without needing to hold the image capture device themselves.

Further, the cover may conceal the image capture device from the child and so the child may not be distracted by the image capture device. The cover may disguise the image capture device by obscuring the recognisable rectangular outline and may also make the lens more difficult for a child to see.

The cover may comprise an opaque portion arranged to at least partially obscure the image capture device and a window arranged to permit image capture by the image capture device through the window. The window may generally be considered as any portion that allows the image capture device to capture images through the cover. The window may be referred to as a non-opaque portion. In this way, the cover may more completely obscure the image capture device and the cover may have a shape different from that of a conventional image capture device, such as the rectangular shape of a mobile phone, such that the child may not recognise the image capture device.

The window may comprise two-way material, such as a two-way film arranged to obscure the image capture device and to permit the image capture device to receive light through the window such that the image capture device may be able to capture images through the window. The window may be covered by a thin, flexible film or may be covered by a substantially rigid pane. The use of two-way material may prevent a child from seeing the lens of the image capture device and so the child may see their own reflection and may be less likely to be distracted by their reflection than by the lens of a recording device.

The cover may have the shape of a character, such as a human or animal figure, or of the face of such a character and the window may be a part of the character, such as the mouth of the character. The window may therefore be disguised. In particular, the window may have a non-rectangular and non-circular shape, which may further obscure the presence of the image capture device.

The cover may be removably coupled to the holding portion. This may allow a user to position the image capture device relative to the book while holding the holding portion more easily without the cover and this may also allow the cover to be changed. For example, the cover may be decorated to be complementary to the subject matter of a book and may be exchanged for a different cover, which may be decorated in the manner that is complementary to a different book. In this way, the cover may be associated by a child more closely with the book than with an image capture device.

The holding portion may comprise a recess arranged to receive the image capture device. A recess may be a particularly easy way to receive a rectangular image capture device, such as a mobile phone having a camera and may be also ensure that the image capture device is obscured from a greater range of angles, avoiding the child seeing the image capture device by looking around the cover.

The recess may be arranged on a second side of the holding portion, the second sloping opposite to the first side. This may allow the image capture device to be coupled to and uncoupled from the image capture device holder without affecting the coupling between the holder and the book.

The recess may comprise a movable wall arranged to vary the size of the recess and optionally may comprise a biasing means arranged to bias the movable wall to reduce the size of the recess. By providing a moveable wall and a biasing means, there may be provided an easier way to couple and decouple an image capture device to and from a holder. In particular, the moveable wall may be suitable for coupling a large number of differently sized and shaped image capture devices to the holder.

The moveable wall may be moveable relative to the cover. In this way, the recess may have stationary walls that are stationary relative to the moveable wall and stationary relative to the cover and therefore the lens of the image capture device may be located in substantially similar places for a variety of different image capture devices, such as mobile phones of differing size and specification. This may allow the same holder to be used with a greater number of image capture devices.

The holding portion may be arranged to project over the top of a book by less than 3 cm. In this way, the majority of the image capture device may be concealed by the book itself and so the prospect of the child identifying the image capture device may be reduced.

The holding portion may be arranged to hold a mobile phone comprising a camera. Since mobile phones holding cameras are ubiquitous, they provide an easily available image capture device and the holding portion may have a substantially rectangular recess or at least a recess having two opposing parallel edges, one of which is moveable, in order to hold a mobile phone comprising a camera.

The image capture device holder may further comprise a second cover, the second cover being couplable to the holding portion in place of the first cover. This may allow the cover to be changed depending on the book being used, so that the cover may be associated with the book.

According to a second aspect of the invention, there is provided a method of recording a reader of a book and/or a person having a book read to them, the method comprising: coupling an image capture device to an image capture device holder such that the image capture device is fixed relative to the image capture device holder; coupling the image capture device holder to a book such that the image capture device is arranged to record a reader of the book; concealing the image capture device from the reader by coupling a cover to the image capture device holder; and recording the reader of the book with the image capture device.

With such a method, a reader of a book and/or a person having a book read to them, which may be a child, may be recorded without the child being distracted by the presence of an image capture device and the footage obtained may therefore be of improved quality relative to footage captured by an image capture device that is visible to the child.

The method may further comprise decoupling the cover from the image capture device holder; coupling a second cover to the image capture device holder; and concealing the image capture device from the reader using the second cover.

In this way, the cover may be selected in order to fit with a decorative aesthetic of a book and may therefore be associated with the book by the child.

The method of the second aspect may be carried out using the image capture device holder of the first aspect.

According to a further aspect of the invention, there is provided an image capture device including the image capture device holder of the first aspect and a mobile phone arranged to capture an image of the reader via a window of the cover.

According to a still further aspect of the invention, there is provided an image capture device holder comprising the image capture device holder of the first aspect and a book, wherein the image capture device holder is coupled to the book.

### BRIEF DESCRIPTION OF THE DRAWINGS

FIG. 1 shows an image capture device holder according to the invention coupled to a book;

FIG. 2 shows a partially disassembled image capture device holder according to the invention coupled to a book;

FIGS. 3 and 4 show a partially disassembled image capture device holder according to the invention from different angles;

FIG. 5 shows an image capture device holder according to the invention incorporating an image capture device; and

FIG. 6 shows a cover of an image capture device holder according to the invention

### DETAILED DESCRIPTION

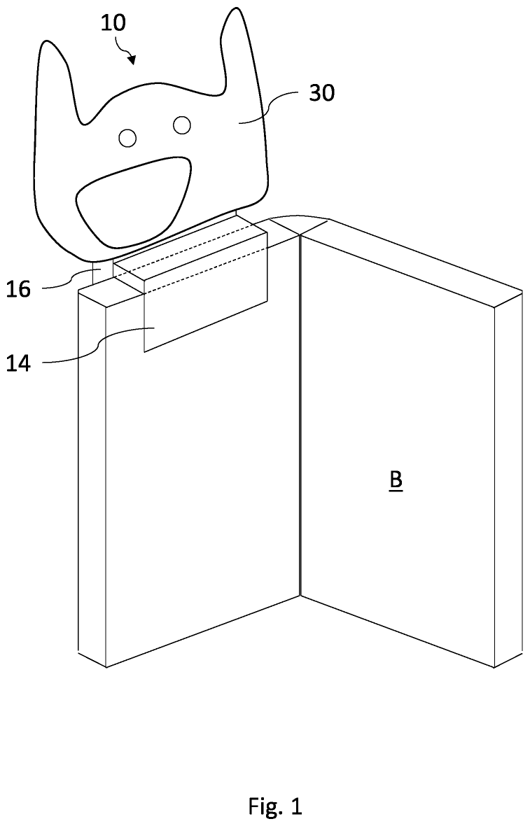

FIG. 1 shows an image capture device holder 10 coupled to a book B. The book B may be any conventional book having a plurality of leaves or pages bound together at a spine. The book B and the image capture device holder 10 may be considered together as a single, image capture device in some cases.

The image capture device holder 10 has a connector 14 which is arranged to couple to the book B. The connector 14 may be recognisable as being couplable to a book by having a recess arranged to receive one or more pages of a book, which may include the front and/or back cover of the book. In some cases, the connector 14 may have a flat horizontal surface arranged to abut a top edge of a book such that the connector 14 may rest on the top edge of the book B, holding the image capture device holder 10 in place. The connector 14 may therefore have an elastic portion which is deformable and may provide a restoring force when deformed such that it may grip one or more pages of a book.

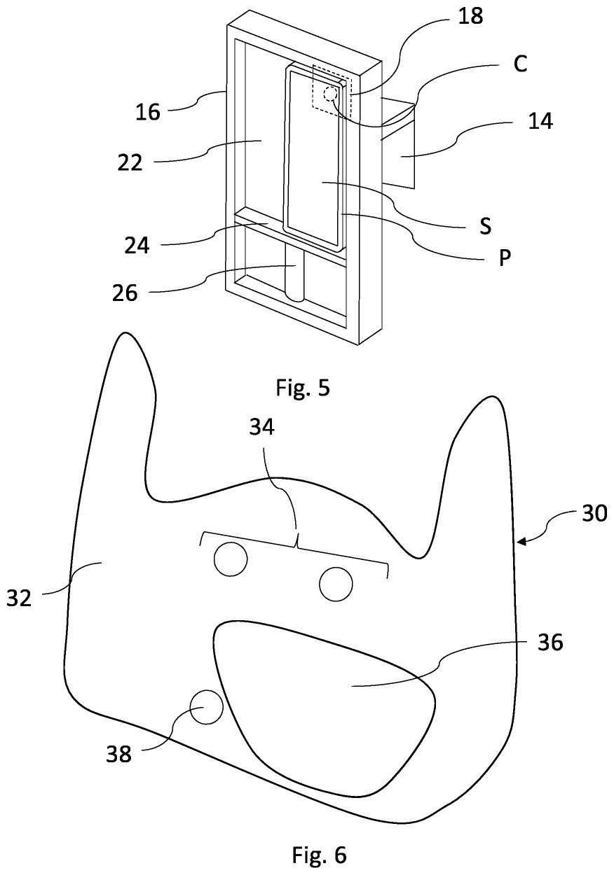

The image capture device holder 10 also has a cover 30, which is arranged to obscure the image capture device and an image capture device holding portion 16, arranged to hold an image capture device. The holding portion 16 and cover 30 are explained in greater detail with reference to FIGS. 5 and 6 respectively.

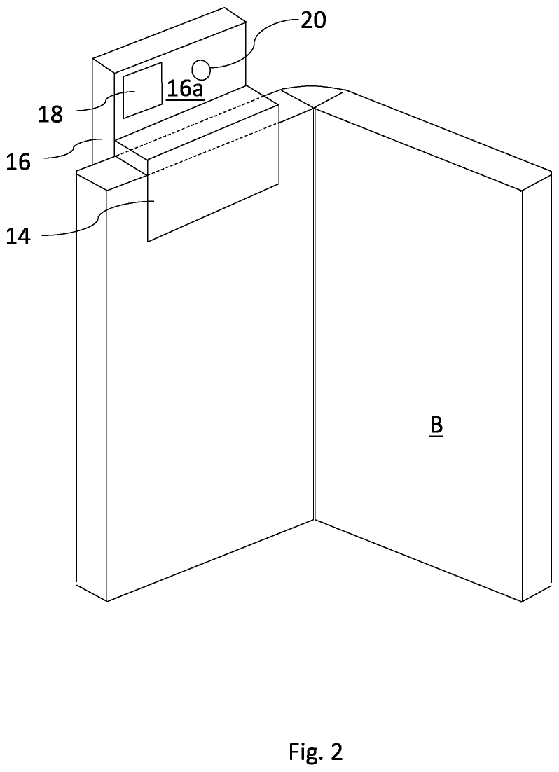

FIG. 2 shows the image capture device holder 10 with the cover 30 removed. In FIG. 2, it can be seen that the holding portion 16 has a holding portion window 18. The holding portion window 18 is positioned and sized to allow the lenses of a range of image capture devices to be positioned in the holding portion window 18 when they are held by the holding portion 16. While the holding portion window 18 is shown as a rectangle, it will be understood that the holding portion window 18 may be any shape and size as required in order to allow an image capture device to view a scene through the holding portion window 18. The holding portion window 18 may be a cut out and provide a void in the holding portion 16 or may have a transparent material, such as Perspex, covering it. Providing a transparent material over the holding portion window 18 may improve protection of the lens of the image capture device.

The holding portion 16 also has a magnet 20. The magnet 20 is arranged to couple the holding portion 16 to the cover 30, which may have a corresponding magnetic portion, optionally a ferromagnetic portion. It will be understood that the cover 30 and holding portion 16 may be coupled by any means and not exclusively by magnets. For example, clips or Velcro may be used to couple the holding portion 16 to the cover 30. The magnet 20 and connector 14 are arranged on the same side of the holding portion 16, which is the first side 16a. By arranging the connector 14 and the magnet 20 on the first side 16a of the holding portion 16, the cover 30 may be arranged between the image capture device and the subject, i.e. the child, being imaged or recorded. Further, the holding portion 16 may be arranged outside the book such that the pages of the book are less obscured.

A portion of the connector 14 may be made transparent in order to allow the pages of the book B to be read and not to be obscured by the connector 14.

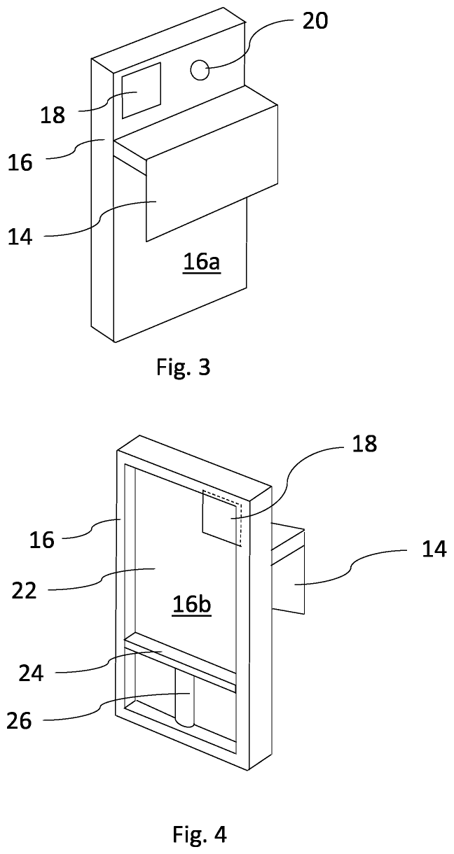

FIGS. 3 and 4 show the image capture device holder 10 with the cover 30 removed. In FIG. 3, it can be seen that the connector 14 is coupled to the holding portion 16 above a midpoint of the holding portion 16. This means that the image capture device may be substantially concealed from the subject by the book and only a small portion of the image capture device may extend above the book.

Turning to FIG. 4, it can be seen that the holding portion 16 has a recess 22 on a second side 16b of the holding portion 16, such that the recess 22 is on an opposite side from the connector 14.

The holding portion 16 has a moveable wall 24, the movement of which may change the size of the recess 22. The moveable wall 24 may therefore be moved to grip an image capture device in order to hold the image capture device in place. It is noteworthy that the moveable wall 24 is moveable relative to the window 18, which is fixed in position. This may allow a greater number of image capture devices to be used with a lens position adjacent the window 18 such that images may be recorded through the window 18.

The holding portion 16 also has a biasing means 26, which may be a spring, which is arranged to urge the moveable wall 24 in order to reduce the size of the recess 22. The biasing means 26 may therefore be used to grip an image capture device with the moveable wall 24 firmly in order to prevent the image capture device moving during recording.

The moveable wall 24 may have a deformable upper surface, such as a sprung or cushioned surface facing the recess 22 in order to further improve the stability of the image capture device.

An image capture device, which may be a mobile phone P, may be received in the recess 22 as shown in FIG. 5. The image capture device P in this case is a mobile phone having a screen S on one side and a camera C on an opposite side. It is common for such image capture devices to have a substantially quadrilateral shape including parallel sides and therefore the moveable wall 24 and an opposing wall of the recess 22 may clamp the image capture device P resiliently between them, in particular by the force of the biasing means 26. The window 18 may also be positioned such that a camera C of the image capture device P is arranged adjacent to the window and is directed to receive light that has passed through the window 18.

The recess 22 may also provide a sufficiently large opening that a screen S of the image capture device P may be visible to a user and therefore the screen S may be used as a view finder to position the image capture device holder appropriately.

FIG. 6 shows the cover 30. In particular, FIG. 6 shows a reverse side of the cover 30 from the side shown in FIG. 1. The cover 30 in this case has the image of a face of a character which may have features such as eyes 34 and a mouth 36. The features may also double up as the window and, in this case, the mouth 36 may also be the window 36. By using the features of a face as a window, the conspicuousness of the window may be reduced.

The cover 30 may also have a magnet or magnetic portion 38 arranged to couple to the holding portion 16. It will be understood that the magnet 38 may be positioned to be adjacent the magnet 20 of the holding portion 16 when the window 36 is adjacent the holding portion window 18.

The cover 30 may be positioned sufficiently close to the holding portion 16 and to the image capture device that there may be minimal light reflected from the lens of the image capture device through the window, such that two-way film over the window 18 and/or the window 36 of the cover may appear as a mirrored surface to a subject on the opposite side of the two-way film.

While reference is made throughout this application to an image capture device, it will be understood that any camera or other image capture device may be used and that the image capture device may be a mobile phone incorporating a camera or another system. For example, an image capture device such as a conventional camera have a screw mount for coupling to a tripod may be used and the holding portion 16 may comprise a corresponding male threaded member for receipt in a screw hole of a camera.

1. An image capture device holder comprising:
a holding portion for holding an image capture device;
a connector disposed on a first side of the holding portion, the connector being arranged to couple the image capture device holder to a book; and
a cover coupled to the holding portion and arranged on the first side of the holding portion, the cover and/or the holding portion being arranged to obscure the image capture device from a viewer facing the first side of the holding portion, while allowing the image capture device to capture one or more images in the direction of the first side.

2. The image capture device holder of claim 1, wherein the cover comprises an opaque portion arranged to at least partially obscure the image capture device and a window arranged to permit image capture by the image capture device through the window.

3. The image capture device holder of claim 2, wherein the window comprises a two-way mirror, optionally a two-way film, arranged to obscure the image capture device and to permit the image capture device to receive light through the window such that the image capture device is able to capture images through the window.

4. The image capture device holder of claim 1, wherein the cover is removably coupled to the holding portion.

5. The image capture device holder of claim 1, wherein the holding portion comprises a recess arranged to receive the image capture device.

6. The image capture device of claim 5, wherein the recess is arranged on a second side of the holding portion, the second side being opposite to the first side.

7. The image capture device holder of claim 5, wherein the recess comprises a moveable wall arranged to vary the size of the recess.

8. The image capture device holder of claim 7, further comprising a biasing means arranged to bias the moveable wall to reduce the size of the recess.

9. The image capture device holder of claim 7, wherein the moveable wall is moveable relative to the cover.

10. The image capture device holder of claim 1, wherein the connector is coupled to the holding portion above a midpoint of the holding portion.

11. The image capture device holder of claim 1, wherein the holding portion is arranged to hold a mobile phone comprising a camera.

12. The image capture device holder of claim 1, further comprising a second cover, the second cover being coupleable to the holding portion in place of the first cover.

13. A method of capturing an image of a reader of a book and/or a person having a book read to them, the method comprising:
coupling an image capture device to an image capture device holder such that the image capture device is fixed relative to the image capture device holder;
coupling the image capture device holder to a book such that the image capture device is arranged to record a reader of the book and/or a person having a book read to them;
concealing the image capture device from the reader and/or the person having a book read to them by coupling a cover to the image capture device holder; and
capturing an image of the reader of the book and/or the person having a book read to them.

14. The method of claim 13, further comprising:
decoupling the cover from the image capture device holder;
coupling a second cover to the image capture device holder; and
concealing the image capture device from the reader using the second cover.

15. The method of claim 13, wherein the image capture device holder is the image capture device holder of claim 1.
